(19) United States
(12) Patent Application Publication
(10) Pub. No.: US 2024/0372890 A1
(43) Pub. Date: Nov. 7, 2024

(54) METHOD AND APPARATUS FOR PREDICTING CYBER THREATS USING NATURAL LANGUAGE PROCESSING

(71) Applicant: Electronics and Telecommunications Research Institute, Daejeon (KR)

(72) Inventors: Young Ho KIM, Daejeon (KR); Seon Gyoung SOHN, Daejeon (KR); Kyeong Tae KIM, Daejeon (KR); Jeong Nyeo KIM, Daejeon (KR); Yun Kyung LEE, Daejeon (KR)

(73) Assignee: Electronics and Telecommunications Research Institute, Daejeon (KR)

(21) Appl. No.: 18/650,568

(22) Filed: Apr. 30, 2024

(30) Foreign Application Priority Data
May 4, 2023 (KR) 10-2023-0058444

(51) Int. Cl. H04L 9/40; G06F 40/20

(52) U.S. Cl. CPC H04L 63/1441; G06F 40/20

(57) ABSTRACT

A method and an apparatus for predicting cyber threats using natural language processing are disclosed. According to an embodiment of a present disclosure, a method for predicting cyber threats includes calculating similarity using a first embedding vector for cyber threat identification information and a second embedding vector for asset information when security event information is received, wherein the security event information includes the cyber threat identification information. The method also includes measuring correlation between the cyber threat identification information and the asset information based on the similarity. The method also includes determining an asset vulnerable to cyber threats based on the correlation.

### CROSS-REFERENCE TO RELATED APPLICATIONS

The present application is based on, and claims priority from, Korean Patent Application Number 10-2023-0058444, filed May 4, 2023, the disclosure of which is incorporated by reference herein in its entirety.

### TECHNICAL FIELD

The present disclosure relates to a method and an apparatus for predicting cyber threats using natural language processing. More specifically, the present disclosure relates to a method and an apparatus for monitoring cyber threats and predicting cyber threats using correlation between an asset to be protected and cyber threat identification information.

### BACKGROUND

The statements in this section merely provide background information related to the present disclosure and do not necessarily constitute prior art.

Hacking incidents arise from vulnerabilities in hardware or software responsible for managing assets. These vulnerabilities stem from diverse sources, including vulnerabilities in web infrastructure, operating system (OS) components, and applications. Because hackers continue to attack assets using the same vulnerabilities, preemptive preparation is required for assets equipped with vulnerable hardware or software. Following a hacking attack or security breach, analysts generate a large amount of cyber threat information on the vulnerabilities. The cyber threat information is presented in unstructured natural language along with identifiers, making it more human-friendly than machine-readable. Accordingly, it takes a lot of time for managers to make and execute decisions necessary to respond to cyber threats.

Recently, a technology is emerging to forecast high-risk assets by comparing vulnerable product names with asset information within cyber threat information. Manufacturers often employ identical technology for various products release under different names. Given the distinct product names, it is difficult to accurately predict cyber threats based simply on string-level comparisons. Accordingly, there is a need to predict cyber threats through comprehensive similarity analysis using natural language processing.

### SUMMARY

The present disclosure may forecast assets vulnerable to cyber threats against cyber threats.

Also, according to one embodiment, an embedding vector may be generated from cyber threat information, cyber threat identification information, and asset information.

Also, according to one embodiment, a correlation difficult to estimate from notational comparisons between asset information and vulnerable product information in cyber threat information may be determined.

Also, according to one embodiment, a preemptive response may be made to safeguard assets vulnerable to cyber threats.

Technical objects to be achieved by the present disclosure are not limited to those described above, and other technical objects not mentioned above may also be clearly understood from the descriptions given below by those skilled in the art to which the present disclosure belongs.

According to the present disclosure, a method for predicting cyber threats includes calculating similarity using a first embedding vector for cyber threat identification information and a second embedding vector for asset information when security event information is received, wherein the security event information includes the cyber threat identification information. The method also includes measuring correlation between the cyber threat identification information and the asset information based on the similarity. The method also includes determining an asset vulnerable to cyber threats based on the correlation.

According to the present disclosure, an apparatus for predicting cyber threats includes a memory and a plurality of processors. At least one of the plurality of processors is configured to calculate similarity using a first embedding vector for cyber threat identification information and a second embedding vector for asset information when security event information is received. The at least one of the plurality of processors is also configured to measure correlation between the cyber threat identification information and the asset information based on the similarity. The at least one of the plurality of processors is also configured to determine assets vulnerable to cyber threats based on the correlation. And wherein the security event information includes the cyber threat identification information.

According to the present disclosure, a computer-readable recording medium is a computer-readable recording medium storing instructions, the instructions, when executed by the computer, may cause the computer to perform calculating similarity using a first embedding vector for cyber threat identification information and a second embedding vector for asset information when security event information is received, wherein the security event information includes the cyber threat identification information. The instructions, when executed by the computer, may also cause the computer to perform measuring correlation between the cyber threat identification information and the asset information based on the similarity. The instructions, when executed by the computer, may also cause the computer to perform determining an asset vulnerable to cyber threats based on the correlation.

### Advantageous Effects

The present disclosure has an effect of forecasting assets vulnerable to cyber threats against cyber threats.

Also, according to one embodiment, there is an effect of generating an embedding vector from cyber threat information, cyber threat identification information, and asset information.

Also, according to one embodiment, there is an effect of determining a correlation difficult to estimate from notational comparisons between asset information and vulnerable product information in cyber threat information.

Also, according to one embodiment, there is an effect of making a preemptive response to safeguard assets vulnerable to cyber threats.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a block diagram illustrating a system for predicting cyber threats according to one embodiment of the present disclosure.

FIG. 2 illustrates a system for predicting cyber threats according to one embodiment of the present disclosure.

FIG. 3 illustrates correlation between cyber threat identification information, cyber threat information, and asset information according to one embodiment of the present disclosure.

FIG. 4 illustrates a structure of cyber threat information according to one embodiment of the present disclosure.

FIG. 5 illustrates a structure of asset information according to one embodiment of the present disclosure.

FIG. 6 illustrates a security event table according to one embodiment of the present disclosure.

FIG. 7 illustrates a method for predicting cyber threats according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

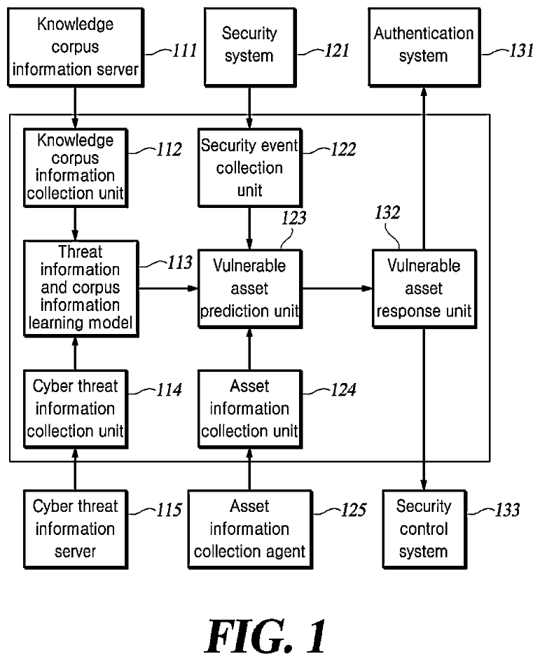

FIG. 1 is a block diagram illustrating a system for predicting cyber threats according to one embodiment of the present disclosure.

Referring to FIG. 1, the system for predicting cyber threats may include a knowledge corpus information collection unit 112, a threat information and corpus information learning model 113, a cyber threat information collection unit 114, and a security event collection unit 122, a vulnerable asset prediction unit 123, an asset information collection unit 124, and a vulnerable asset response unit 132. A learning step, a prediction step, and a response step may be performed using a system that predicts cyber threats. The learning step may include a process of collecting and processing learning data to be used for learning and a process of training a learning model using the learning data.

The cyber threat information collection unit 114 and the knowledge corpus information collection unit 112 may collect two types of information for different learning purposes. The cyber threat information collection unit 114 may collect cyber threat information from the cyber threat information server 115. The knowledge corpus information collection unit 112 may collect knowledge corpus information from the knowledge corpus information server 111. The knowledge corpus information server 111 may provide knowledge information matching a search term in the form of a complete natural language sentence or text through a search function. For example, a knowledge portal service may exist.

The threat information and corpus information learning model 113 may process two types of information collected from outside and use them as learning data for learning natural language processing. Natural language processing is a branch of machine learning technology that empowers computers the ability to interpret, manipulate, and understand human language. In natural language processing, a word embedding technique may be used to convert words into embedding vectors. The word embedding technique corresponds to a technique that expresses words in the form of dense vectors. Cyber threat information and knowledge corpus information may be processed into natural language sentences. These natural language sentences may be used as learning data. The purpose of using the two types of information as learning data may be to obtain embedding vectors of product names vulnerable to cyber threats and to obtain embedding vectors for all words used in asset information.

The threat information and corpus information learning model 113 may correspond to a deep learning-based model. A system that predicts cyber threats may additionally include a learning unit (not shown) to train a learning model in advance. The learning unit may pre-train the learning model using supervised learning, unsupervised learning, semi-supervised learning, and/or reinforcement learning. Here, since the specific method employed by the learning unit to train the learning model based on the learning data is commonly understood in the corresponding field, detailed descriptions will be omitted.

The prediction step may be performed when the security event collection unit 122 receives a security event occurring in the external security system 121. The security event collection unit 122 may collect security event information from one or more security systems 121. The purpose of the vulnerable asset prediction unit 123 is to recognize a threat situation through the security event information and identify assets that may be exposed to the threat. The asset information collection unit 124 may collect configuration information on all assets. The asset information collection unit 124 may collect configuration information on individual assets through the asset information collection agent 125.

The vulnerable asset prediction unit 123 may determine configuration information on all assets using the asset information collection unit 124. Asset information collection may not always be performed simultaneously with the reception of the security event information. Asset information may be collected periodically or immediately when current information is needed, regardless of reception of the security event information. The vulnerable asset prediction unit 123 may measure the correlation between cyber threat identification information and asset information identified within the security event information. The vulnerable asset prediction unit 123 may use the correlation to determine the potential risk of the corresponding asset.

In the response step, preemptive measures may be applied to the assets anticipated to be at high risk. The vulnerable asset response unit 132 may respond to cyber threats in conjunction with the authentication system 131 and the security control system 133. Depending on the level of response, a linkage structure between the vulnerable asset response unit 132, the authentication system 131, and the security control system 133 may be determined. The vulnerable asset response unit 132 may immediately block network traffic of vulnerable assets. The vulnerable asset response unit 132 may control the network traffic of the asset through policy establishment of the security control system 133 while continuously monitoring the vulnerable asset. For example, the security control system 133 may correspond to a firewall or an Intrusion Prevention System (IPS).

The vulnerable asset response unit 132 may block access attempts by vulnerable assets or vulnerable asset owners at the service level. The vulnerable asset response unit 132 may control service connection in conjunction with the authentication system 131 while monitoring vulnerable assets. For example, controlling a service connection using the authentication system 131 may be performed by Open Authorization (OAuth). OAuth is a common means for Internet users to grant websites or applications access to their information on other websites without providing a password. For example, controlling a service connection using the authentication system 131 may be performed by the OpenID connect protocol. The OpenID connect protocol corresponds to an open standard protocol used for user authentication. The linkage structure of the vulnerable asset response unit 132 and the authentication system 131 may be used to dynamically control the service connection depending on the risk of the asset or asset user.

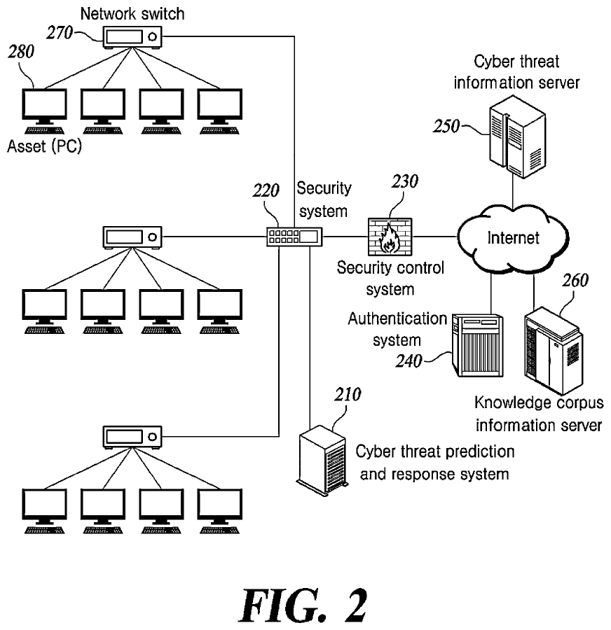

FIG. 2 illustrates a system for predicting cyber threats according to one embodiment of the present disclosure.

Referring to FIG. 2, a system that predicts cyber threats may safely protect assets anticipated to be at risk from security event information. Basic learning data may be collected from the cyber threat information server 250 and the knowledge corpus server 260. PCs may correspond to assets 280. Assets 280 may constitute an internal network. Asset configuration information may be collected in real-time through an asset information collection agent (not shown) within the assets 280. The asset configuration information may be transmitted to the cyber threat prediction and response system 210. The cyber threat prediction and response system 210 may receive security event information in real-time from the security system 220. The security event information may include information on the threat situation that occurs in real-time.

The cyber threat prediction and response system 210 may receive security event information and use asset information to recognize assets at high risk. The cyber threat prediction and response system 210 may respond to cyber threats in conjunction with the security control system 230 depending on the response level. The cyber threat prediction and response system 210 may respond to cyber threats at the user level in conjunction with the authentication system 240 depending on the response level. The cyber threat prediction and response system 210 may block or control network traffic of vulnerable assets using the network switch 270.

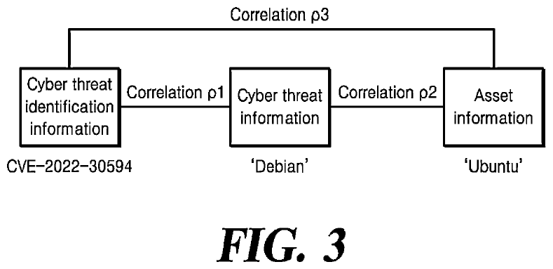

FIG. 3 illustrates correlation between cyber threat identification information, cyber threat information, and asset information according to one embodiment of the present disclosure.

Referring to FIG. 3, for example, CVE-2022-30594 may correspond to cyber threat identification information. According to the national vulnerability database of the National Institute of Science and Technology (NIST), CVE-2022-30594 may utilize the permission of the Linux kernel. Therefore, CVE-2022-30594 may also be found in Linux products distributed by Debian. CVE-2022-30594 may be added as a new corpus meant to uniquely identify cyber threats of a specific year. The new corpus may have implications for the Linux kernel, permissions, and Debian Linux. In particular, the new corpus may have a close relationship with Debian Linux. According to the example, CVE-2022-30594 and Debian Linux have a significant correlation ρ1.

The correlation ρ2 between cyber threat information and asset information may be derived using word pivoting. Knowledge corpus information is used as learning data to create embedding vectors that reflect the relationship between the two pieces of information. For example, knowledge corpus information may correspond to online technical reports written in natural language, information in magazines, information in newspapers, or information in blogs. Each name of asset information may be retrieved from the knowledge corpus information server. Depending on a query, the entire document or text containing matching words may be used as learning data.

Not only asset information but also vulnerable product names of cyber threat information may be retrieved from the knowledge corpus information server. Depending on a query, the entire document or text containing matching words may be used as learning data. For example, the Linux operating system products Debian and Ubuntu are completely different words in notation, but correlation ρ2 may be derived through learning using knowledge corpus information. Through learning of the knowledge corpus information according to the present disclosure, the correlation ρ2 between the asset information and the corpus within the cyber threat information may later be expressed as a quantitative embedding vector.

The cyber threat identification information and all words for asset information may be expressed as embedding vectors. Using the embedding vectors, the correlation ρ3 between cyber threat identification information and asset information may be calculated. Using correlation ρ3, the potential risk of the corresponding asset may be determined. Quantitative comparison and evaluation may be made using embedding vectors. For example, the degree of correlation between two vectors may be measured using Euclidean distance. For example, the degree of correlation between two vectors may be measured using cosine similarity.

For example, the embedding vector of cyber threat identification information A may correspond to vA, and the embedding vector of asset information B may correspond to vB. The inner product between the embedding vector of the cyber threat identification information A and the embedding vector of the asset information B may correspond to vA-vB. The length of the embedding vector of the cyber threat identification information A may correspond to ∥vA∥. The length of the embedding vector of the asset information B may correspond to ∥vB∥. The degree of correlation between the cyber threat identification information A and the asset information B may be calculated according to the cosine similarity of Eq. 1.

$$cos θ = \frac{{v}_{A} \cdot {v}_{B}}{‖ {v}_{A} ‖ ‖ {v}_{B} ‖} \qquad [ Eq . 1 ]$$

Assets whose cosine similarity is expressed by a large value may be determined to have a high risk of being exposed to threats due to the corresponding security event. If an asset has a plurality of configuration information, the average value of the embedding vectors of the configuration information may be used as a representative value. Using the cosine similarity, the correlation ρ3 between cyber threat identification information and asset information may be calculated.

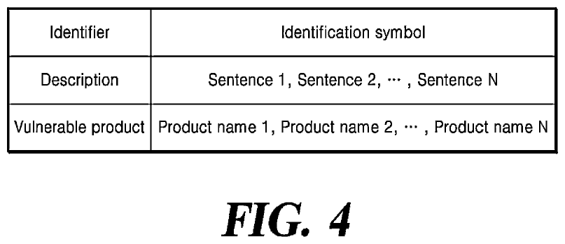

FIG. 4 illustrates a structure of cyber threat information according to one embodiment of the present disclosure.

Referring to FIG. 4, cyber threat information may include an identifier, a description, and an affected product. The identifier may comprise an identification symbol. The identifier may be composed of sentences using connecting words to learn from a corpus having a correlation with cyber threat identification information. Through the composition, a correlation may be established between cyber threat identification information and identifiers in natural language processing, where learning is effective in units of sentences. The description part may comprise one or more sentences. A cyber threat identifier may be inserted into each individual sentence of the description part along with a linking preposition to form sentences for learning. For example, a preposition may correspond to Through. For example, if there is one sentence, the description part may be composed of Through[identifier][sentence]. For example, if there are two or more sentences, the description part may be composed of Through[identification symbol][sentence 1], Through[identification symbol][sentence 2], . . . , and Through[identification symbol][sentence N].

The affected product part may be composed of one or more product names. Because the affected product part is described in a noun form, the affected product may consist of an identifier and one or more product names along with a linking verb instead of a preposition. For example, the verb may correspond to affect. For example, if there is only one product name, the affected product part may consist of [identification symbol]affects[product name]. For example, if there are two or more product names, the affected product part may be composed of [identification symbol]affects[product name 1], [identification symbol]affects[product name 2], . . . , and [identification symbol]affects[product name N]. Prepositions and verbs used in the description and affected product parts are expressed in English but are not limited to a specific language. Also, example words used as linking words are not limited to a specific language. The purpose of the learning data is to enable the corpora comprising cyber threat information to form correlation ρ1 with cyber threat identification information through the learning process.

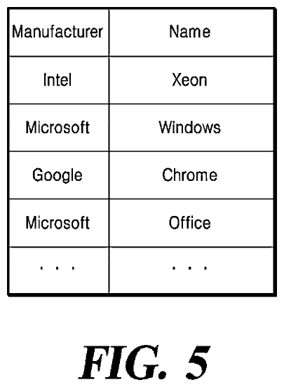

FIG. 5 illustrates a structure of asset information according to one embodiment of the present disclosure.

Referring to FIG. 5, asset information is information on the hardware manufacturer, operating system, or application programs constituting the asset, which may be expressed as a noun name. Here, additional numerical information such as version may be treated as a single word. Numeric information may be preprocessed to be excluded. For example, asset information may be composed of the manufacturer, Intel, and the product name, Xeon. For example, asset information may be composed of the manufacturer, Microsoft, and the product name, Windows. For example, asset information may be composed of the manufacturer, Google, and the product name, Chrome. For example, asset information may be composed of the manufacturer, Microsoft, and the product name, Office.

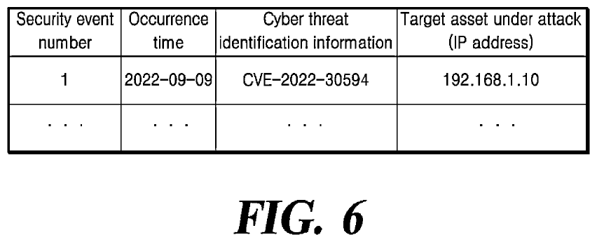

FIG. 6 illustrates a security event table according to one embodiment of the present disclosure.

Referring to FIG. 6, security event information is a message containing cyber threat identification information and may be used to detect and propagate a threat situation. Cyber threat identification information within security event information may be used as a pivot. Once the cyber threat identification information is confirmed, a prediction step may be performed. The security event table may be composed of the security event number, occurrence time, cyber threat identification information, and IP address of the target asset under attack. For example, the security event table may include the security event information specifying that the security event number is 1, the occurrence time is Sep. 9, 2022, the cyber threat identification information is CVE-2022-30594, and the IP address of the target asset under attack is 192.168.1.10.

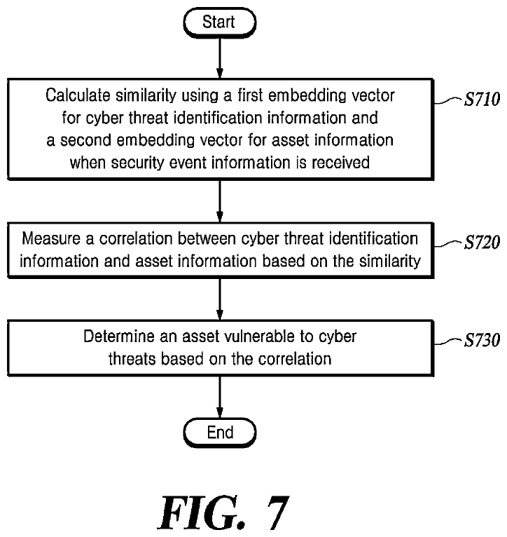

FIG. 7 illustrates a method for predicting cyber threats according to one embodiment of the present disclosure.

Referring to FIG. 7, when receiving security event information, the apparatus for predicting cyber threats may calculate the similarity using a first embedding vector for cyber threat identification information and a second embedding vector for asset information S710. The apparatus for predicting cyber threats may measure the correlation between cyber threat identification information and asset information based on the similarity S720. The correlation ρ3 between cyber threat identification information and asset information may be measured from quantatitive computations of embedding vectors by combining the correlation ρ1 between cyber threat identification information and cyber threat information and the correlation ρ2 between cyber threat information and asset information.

The first and second embedding vectors may be obtained after training of the learning model is completed. The learning model may use the cyber threat information and the knowledge corpus of the asset information as training data. Cyber threat information may include at least one of the identifier, description, and affected product. The structure of the description may be composed in the order of preposition, identifier, and sentence. The structure of the affected product may be composed in the order of the identifier, verb, and affected product name.

When asset information has a plurality of configuration information, the second embedding vector may correspond to the average value of a plurality of embedding vectors for the plurality of configuration information. The asset information may include at least one of manufacturer information and product name information.

The apparatus for predicting cyber threats may determine assets vulnerable to cyber threats based on correlation S730. The apparatus for predicting cyber threats may perform preemptive countermeasures to safeguard determined assets against cyber threats. The performing of the countermeasures may include controlling network traffic for determined assets. The performing of the countermeasures may include controlling the service connection to the determined assets in conjunction with an authentication server at the user level.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method performed by an apparatus for predicting cyber threats, the method comprising:
calculating similarity using a first embedding vector for cyber threat identification information and a second embedding vector for asset information when security event information is received, wherein the security event information includes the cyber threat identification information;
measuring correlation between the cyber threat identification information and the asset information based on the similarity; and
determining an asset vulnerable to cyber threats based on the correlation.

2. The method of claim 1, further comprising:
performing countermeasures to safeguard the determined asset against cyber threats.

3. The method of claim 1, wherein the correlation between the cyber threat identification information and the asset information is measured based on a first correlation between the cyber threat identification information and cyber threat information and a second correlation between the cyber threat information and the asset information.

4. The method of claim 1, wherein the first embedding vector and the second embedding vector are obtained using a learning model, and
the learning model uses cyber threat information and knowledge corpus information as training data.

5. The method of claim 3, wherein the cyber threat information includes at least one of an identifier, a description, and an vulnerable product.

6. The method of claim 5, wherein a structure of the description is composed in the order of preposition, identifier, and sentence, and
a structure of the vulnerable product is composed in the order of the identifier, verb, and vulnerable product name.

7. The method of claim 1, wherein, if the asset information has a plurality of configuration information, the second embedding vector corresponds to an average value of a plurality of embedding vectors of the plurality of configuration information.

8. The method of claim 1, wherein the asset information includes at least one of manufacturer information and product name information.

9. The method of claim 2, wherein performing the countermeasures comprises controlling network traffic for the determined asset.

10. The method of claim 2, wherein performing the countermeasures comprises controlling a service connection for the determined asset in conjunction with an authentication server.

11. An apparatus for predicting cyber threats, the apparatus comprising:
a memory; and
at least one processor, wherein the at least one processor is configured to:
calculate similarity using a first embedding vector for cyber threat identification information and a second embedding vector for asset information when security event information is received;
measure correlation between the cyber threat identification information and the asset information based on the similarity; and
determine assets vulnerable to cyber threats based on the correlation,
wherein the security event information includes the cyber threat identification information.

12. The apparatus of claim 11, wherein the at least one processor performs countermeasures to safeguard the determined asset against cyber threats.

13. The apparatus of claim 11, wherein the correlation between the cyber threat identification information and the asset information is measured based on a first correlation between the cyber threat identification information and cyber threat information and a second correlation between the cyber threat information and the asset information.

14. The apparatus of claim 11, wherein the first embedding vector and the second embedding vector are obtained using a learning model, and
the learning model uses cyber threat information and knowledge corpus information as training data.

15. The method of claim 13, wherein the cyber threat information includes at least one of an identifier, a description, and an vulnerable product.

16. The apparatus of claim 15, wherein a structure of the description is composed in the order of preposition, identifier, and sentence, and
a structure of the vulnerable product is composed in the order of the identifier, verb, and vulnerable product name.

17. The apparatus of claim 11, wherein, if the asset information has a plurality of configuration information, the second embedding vector corresponds to an average value of a plurality of embedding vectors of the plurality of configuration information.

18. The apparatus of claim 11, wherein the asset information includes at least one of manufacturer information and product name information.

19. The apparatus of claim 12, wherein the at least one processor controls network traffic for the determined asset.

20. A computer-readable recording medium storing commands, wherein, when the commands are executed by the computer, the commands instruct the computer to perform:
calculating similarity using a first embedding vector for cyber threat identification information and a second embedding vector for asset information when security event information is received, wherein the security event information includes the cyber threat identification information;
measuring correlation between the cyber threat identification information and the asset information based on the similarity; and
determining an asset vulnerable to cyber threats based on the correlation.
